(19) United States
(12) Patent Application Publication
(10) Pub. No.: US 2024/0321132 A1
(43) Pub. Date: Sep. 26, 2024

(54) Electromechanical System and Method to Proctor Online Examinations

(71) Applicant: Duquesne University of the Holy Spirit, Pittsburgh, PA (US)

(72) Inventor: Patrick Juola, Pittsburgh, PA (US)

(73) Assignee: Duquesne University of the Holy Spirit, Pittsburgh, PA (US)

(21) Appl. No.: 18/613,589

(22) Filed: Mar. 22, 2024

Related U.S. Application Data
(60) Provisional application No. 63/454,285, filed on Mar. 23, 2023.

(51) Int. Cl. G09B 7/02; G06T 7/20; G06V 40/20

(52) U.S. Cl. CPC G09B 7/02; G06T 7/20; G06V 40/20

(57) ABSTRACT

The present invention is a modular electromechanical system for proctoring an online examination, as to a test-taker at a remote computer location, incorporating modules which collect and compare only motion-detected biometrics. The modules of the system include a computer keyboard or equivalent input device, a User Registration Database, a module for motion sensing (during testing) and data transmission that populates a Motion Capture Database, and a compiler for comparing or contrasting the User Registration Database and the Motion Capture Database, with the compiler's rendering its analytical data to a Secure Compilation Database Storage with User Output. The User Registration Database is populated in advance of the test to be proctored, in a secure setting.

### FIELD OF THE INVENTION

Online Proctoring

### BACKGROUND OF THE INVENTION

In the present day, online communications (audio and video) have become more and more a part of our scholastic and work life. In former days of audio-only telephone conferences, issues of dress codes, backgrounds, ambient noise and activities of other occupants in the room were of limited if any concern. For the most part, the “mute” button was all a telephone conference participant needed, to assure necessary privacy for others in the room (family members, pets, visitors, and so forth). Now, however, classroom and work-life are often conducted intensely if not entirely online, with all new emphases on presentation and privacy issues—viewable backgrounds, numbers of cameras, camera angles and view frames, microphone sensitivities, lighting issues, and so forth. Now, any time an individual participates in an online experience, for the most part everyone and everything else in the room (without intervention) might also be part of the online experience, like it or not.

For voluntary online experiences such as classroom attendance or work participation, up until now issues of privacy have been more or less manageable—by limiting any or all of camera activation or angles, microphone capture volumes, and so forth. Voluntary participation is one thing, however—examination proctoring currently uses different controls, to assure fairness. With these current protocols and technologies, the individual does NOT have, in many cases, the option to limit audio or video exposure. These technologies for proctoring online exams are intrusive even to the point of being onerously revealing—as to every action, activity, sound, and even object in the room where the test is being taken. This can be a breach of the privacy of the test taker. The use of multiple cameras and multiple camera angles includes in the online capture all sorts of things in the room that are not, or should not be, of any concern to the exam proctor. In other words, proctoring microphones and cameras can capture any and all sound in the room, with a camera on the hands, a camera on the face, the camera angles' embracing much or all of the room, and so forth. This audio and video proctoring poses not only a moral privacy question, but can also pose specific security concerns for the test taker—by for example showing online certain architectural features such as location of windows and doors, or “blind spots” created by shrubbery or vegetation outside windows, to name a few.

### BRIEF DESCRIPTION OF THE DRAWINGS

FIG. 1 is a flow chart schematic drawing depicting the method steps and configurations of the present modular electromechanical system.

### BRIEF SUMMARY OF THE INVENTION

In order to provide an easy to implement, unintrusive system and method for proctoring online examinations, the present invention is a modular electromechanical-system for proctoring an online examination, as to a test-taker at a remote computer location, incorporating modules which collect and compare only motion-detected biometrics. The modules of the system include a computer keyboard or equivalent input device, a User Registration Database, a module for motion sensing (during testing) and data transmission that populates a Motion Capture Database, and a compiler (data analysis and comparison module) for comparing or contrasting the User Registration Database and the Motion Capture Database, with the compiler's rendering its analytical data to a Secure Compilation Database Storage with User Output. The User Registration Database is populated in advance of the test to be proctored, in a secure setting. The Secure Compilation Database Storage with User Output reports to a user any variances (after probability analysis) between the User Registration Database and the Motion Capture Database, indicating either test-taking security confirmation or an alert regarding possible cheating.

### DETAILED DESCRIPTION OF THE INVENTION

The present invention is a modular, hardware-dependent system. This particular modular system of the invention detects identity-theft type cheating in a way that the test-taker cannot anticipate or thwart. Identity-theft type cheating is the substitution of a stand-in for the test-taker, whether animal (including humans) or artificially intelligent. The invention is not limited to identify-theft type cheating, however, but can also discern cutting-and-pasting from an external source such as a web site, typing from the dictation or direction of another rather than from the test-taker's own memory or thoughts, or other patterns of input other than the paradigm “thought followed by data entry” of fair test taking. The modularity of the system is intrinsic to the invention, and the modules are discussed below, after an initial conceptual explanation of what the combined modules accomplish and how. The invention does not reside in the concept, however—the invention resides in the modular hardware-containing system described herein.

The disclosed non-invasive method for proctoring limits test-taker surveillance to motion-detected biometrics only, having to do with the keyboard, mouse or trackball (or other input) of the computer being used. While typing speed alone, and variations therefrom, are enough to flag a possible cheating situation (substitution of a human or even animal or artificially intelligent stand-in), typically two or more categories of biometrics would be first registered, then compared, to see if the actual test taker's biometrics match the registered biometrics of the registered test-taker. Biometrics collected and analyzed are “mechanical only,” in the sense that even a fully electronic computer mouse or track pad/trackball is used manually (mechanically) and the space/time motion of the mouse would be what would be monitored—no audio, and no video. The present monitoring and processing of motion detection allows “unique fingerprinting” of the test-taker—as to typing speed, key hold time, key stroke interval, and diagraph latencies, among others. (“Diagraph latency” is the difference between, say the speed of typing “OR” versus “RO,” or “TH” versus “HT,” the former being common combinations and the latter being less used or practiced.) Additional motion-sensed biometrics include, without limitation, key choice patterns (left or right Shift key preference? left or right Control key preference?) or the manner in which the typist deletes input—with the backspace key or the delete key and in what proportion/distribution? Any set or subset of motion-sensed keyboard/input manipulation of the computer during use is suitable as a basis for registration and monitoring, according to this invention. Additional motion detected biometrics are at first blush linguistic—the spelling of colour rather than color, for example, or putting two spaces after a period rather than one space, but even these are mechanical phenomenon that can be motion-sensed, even apart from their linguistic significance.

The ability of computer systems to collect mechanical input biometrics is already known, albeit in a completely different context and without the current modules or results. Computers already collect mechanical input data as “keyboard driver information,” and such data is customarily deleted before the transmission from the keyboard driver “goes to Microsoft.” This means that most or all computer keyboards are already equipped not only with motion sensors but with the data capture and transmission capabilities to populate a database of motion-detected data. In the “spyware” realm, it is already known to capture such motion sensed data, generated by the keyboard, surreptitiously to discern (for example) a user's password as or after the user types it. Therefore, to implement the present invention one adapts an application similar to such known spyware, except that in this instance the application is above-board and for fairness monitoring purposes. The approach for implementing the invention involves the two phase advance collection of registration data (to profile the user) and the collection of direct data during proctoring, with the subsequent comparison of both data sets, with probability analysis, to see how close they are to one another. Individuals could well be expected to have variations in typing speed and so forth, but would not have gross differences in typing speed (absent something explainable. such as having one hand temporarily in a cast or sling). Probability analyses would differentiate minor variations from registration data versus significant variations from registration data—the latter of which would serve as a flag that there might be a security issue to investigate further. The security issue would not be limited to the above-mentioned stand-in type cheating, but would also detect abnormal data entry such as cut-and-paste from a web site, retyping from an external source rather than from memory or thought, typing from dictation or input from another, and so forth.

Regarding the proctoring concept of “investigating further,” no fairness monitoring technology should ever substitute as “judge and jury,” obviously. The present invention is designed to generate, as a user output, what amounts to a red-flag alert that there may well be a problem. Subsequent investigation then amounts to the same inquiry as would ensue with any monitoring system—questions as to possible recent injuries, subjective or objective malaise, or other physical impairments that would explain data variance apart from any cheating on the exam. As part of such an inquiry, too, the opportunity to collect other information from the test taker (anywhere from “leakage” to outright confession) also occurs and can be managed, but these inquiries are not part of the present invention. The instant technology either confirms “a match” between prior collected user registration data and motion sensed data collected during testing, or outputs a “red flag” alert that the data do not match, outside margins of error with probability analysis. In this way, the present output is concrete—either the data matches, or there is a red flag.

As to the nature of the motion-detected data, virtually always if not always the keyboard or other input data will be predominantly or exclusively “timing data.” With exceptions, the overall nature of the motion capture will be motion assessed over time. For example, the arc of sweep of a mouse is a geometric construct—not time related—depending on the style of the user. Likewise, the choice of use of a drop-down menu versus a shortcut keystroke—will be motion data that is not time dependent. Accordingly, the motion detected data is often, but need not always be, time-related data.

In the simplest form of the invention, the present modular system is a “black box” with USB (or equivalent) connections at each end. Typically, first the black box contains the User Registration Database, populated in advance of the testing session, which identifies the biometrics of the test-taker in a previously (prior to proctored exam) securely collected database. Also inside the box is typically, second, hardware to create a separate database, the Motion Detection Database, that is populated during the test session by motion detection data registered by a standard keyboard. (Most or all keyboards are already equipped with motion data capturing technology, as discussed above.) Third, typically the black box is also equipped with either an internal microprocessor, to function as a compiler to compare the two databases, or a transmitter to send either or both of the databases to an external processor. Whether inside the black box or externally configured, the compiler conducts (in effect) a “validation” of the later collected data against the previously collected User Registration Database. If multiple modules are included in a single box as described, the box serves as a hub that validates current input data by collecting current input data for comparison with registered data, processed with an internal microprocessor. Whether the box also contains a third database (for the resulting validation data) and an output to a user is an optional feature—the box can also be transported to a separate processing location for validation and output.

As is apparent from the above, a key module of the present invention is the initial user registration database—of all the keyboard/trackpad/trackball mechanical data that is representative of the user who will be, later, proctored as a test-taker. Creation of the user registration database necessarily occurs prior to testing, and virtually always occurs in a physically proctored setting, rather than a remote or online setting. However, the resulting User Registration Database, once created, can be used limitless times thereafter. The user registration database is secured in appropriate hardware (such as the above mentioned black box) with tamper-proofing, and the hardware then issued to the individual becomes a “key fob” type hardware device that the user can attach to any computer in the future. In other words, after the initial creation of the User Registration Database and the secure storage of the User Registration Database in a suitable hardware device, the user may use it to verify his or her identity in virtually limitless future online testing occasions, without the need for audio or video surveillance while taking exams.

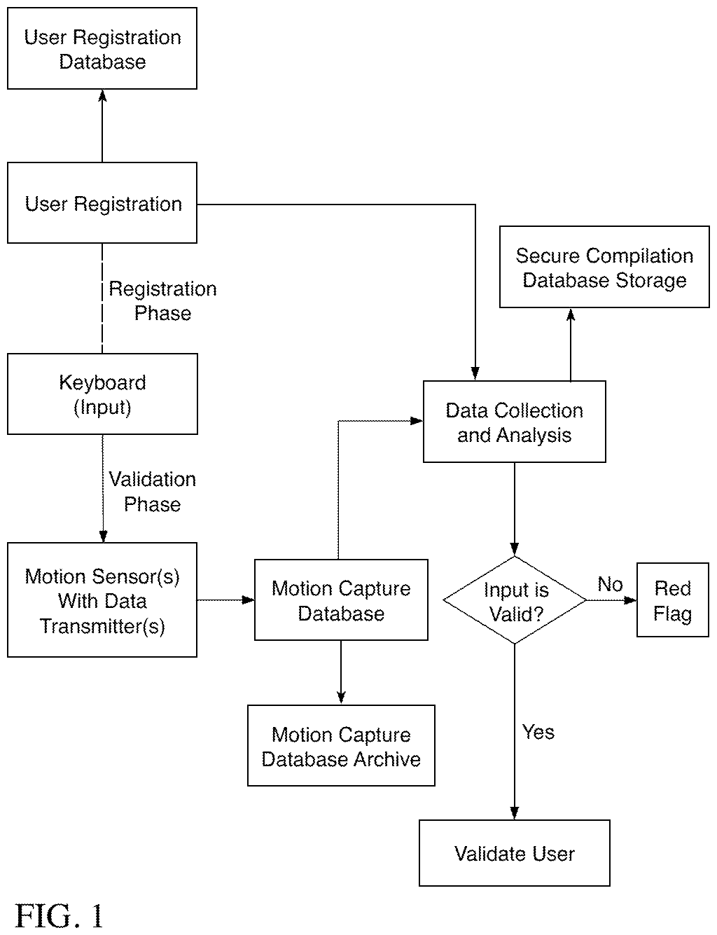

In a commercial embodiment, most or all of the present modules (not the keyboard or input device) might well be combined in the above-described black box, but this does not mean that the invention cannot be implemented with separate modules as well. FIG. 1, discussed below, identifies the modules of the present invention, and such modules may be implemented in one or more hardware constructs without departing from the scope of the invention. The key features of the present invention, regardless of location, are 1) the keyboard or input device with motion sensing capacity; 2) the advance creation of a User Registration Database of motion sensed data unique to the individual User; 3) the construct of a Motion Capture Database able to collect motion sensed data during a test session; and 4) a validation microprocessor to compare the two databases and promulgate a third database with output to a user.

By “USB or equivalent” is meant a WiFi connection, RJ45, Lightning, a serial bus, radio transmitter or transceiver, or basically anything that can connect to the computer being used by the test taker via wire or electromagnetic signal, wire, or similar EMF hereafter developed. The black box itself could even be built directly into the keyboard, with the understanding that by “keyboard” is meant literally any computer input device—keyboard, mouse, scroll wheel, microphone, light pen, track pad, track ball, and so forth. When the black box is built directly into the keyboard, however, the initial user registration database must be securely compiled in advance of test proctoring, and physically secured in such a black box as a separate hardware application.

In order better to describe the above, reference is made to the accompanying FIG. 1.

A User Registration Database is separately compiled as its own module of the present system, connected to a User Registration module which is then optionally connected (hence the dotted line) to a Keyboard (or other input device). The Keyboard is equipped with intrinsic or added motion sensor(s) and data transmitter(s) to interface with “Motion Sensor(s) with Data Transmitter(s)” kept separate from the User Registration Database. The Motion Sensors populate a Motion Capture Database, which in turn feeds both a Motion Capture Database Archive and a Data Collection and Analysis module, which in turn allows a determination of “Input is Valid?” (if No, then “Red Flag”) to Validate a User, if Yes, as well as to populate a Secure Compilation Database Storage. So, as shown in FIG. 1, it is the Motion Sensors and Motion Capture, from the Keyboard Input, that drive the overall identification system, after data collection and analysis.

A key feature of FIG. 1 is that the “User Registration Database” is not only optionally connected to the keyboard of the modular system, but the User Registration Database usually must be linked to the User Registration and be compiled (as described above) as a first step in the method embodied by the modular system. Without initial (advance of proctoring) compilation of the User Registration Database as a separate database, the present modular system will not provide effective proctoring of a test-taking scenario occurring later in time. The alternate scenario of creating a User Registration Database after the fact is tenable, however, when no User Registration Database has been created in advance. Technically, the most important thing is for the User Registration Database to be created at a time separate from the test being proctored, under secure circumstances that can reliably connect the User Registration Database to the individual in question.

For database creation of either the User Registration Database or the Motion Capture Database, Equation 1 (among others) may be used to populate the database.

DE=“m₁,m₂ . . . [m₃₀]” Equation 1

In Equation 1, “m” represents motion and “m₁, m₂ . . . ” represent distinctive motion captured by the keyboard or other input sensors. DE equals the aggregated database entries (comma separated values). The databases described above are populated with each numeric motion's being identical—so if m₁ is key hold length in the User Registration Database, m₁ will be key hold length in the Motion Capture Database, and so forth (for typing speed and other parameters discussed above). Typically no more than 30 motion parameters will be collected in either database, but the invention will work well even when only two motion parameters are collected, so in Equation 1 the upper limit of [m₃₀] is shown in a bracket to indicate that this upper limit is optional, and only two motion parameters are required to populate the two databases.

In rare instances, the User Registration Database may be created after the fact of the test, to provide validation of motion detection during the exam, after the exam. However, the predominant and most useful iteration of the present invention is the initial creation of the User Registration Database, for later comparison and validation against the Motion Capture Database.

The above modular system is indeed often architecturally hard-ware based, but as those skilled in the art will appreciate, the present invention can also be crafted as a software-system to be run on standard computer hardware elsewhere—for the market and consumer benefits that rendering an electromechanical system as a software product clearly provides. Having said that, however, the present invention is “not just software,” because the software MUST be used in association with one or more motion capture devices, such as the keyboard described above, in order to create the biometrics which form the key measurement fodder of the present invention. The present invention therefore provides the ingenious combination of software and motion capture hardware (and data) to provide a novel and nonobvious way to prevent cheating—while avoiding undue breaches of privacy to the user.

Although the technology has been described with particularity in the above description and in FIG. 1, the invention is only to be limited insofar as is set forth in the accompanying claims.

I claim:

1. An electromechanical system for proctoring online examinations, comprising:
a User Registration Database;
a Motion Capture Database; and
a processor for validating the degree of similar of said Motion Capture Database to said User Registration Database.

2. The system according to claim 1, wherein said User Registration Database contains motion sensed computer input data according to the equation:
DE=“m₁,m₂ . . . [m₃₀]”
and said Motion Capture Database contains motion sensed computer input data captured from a cooperating motion sensor according to the same equation and collected during a proctored online exam.

2. A method for proctoring an online examination, comprising the steps of:
a) creating a User Registration Database of two or more types of collected user-specific computer input motion sensed data according to the equation:
DE=“m₁,m₂ . . . [m₃₀]”
and affixing said database in dedicated hardware therefor;
b) connecting a Motion Capture Database to a computer input device and populating said Motion Capture Database with two or more types of collected user-specific computer input motion sensed data according to said equation; and
c) validating said Motion Capture Database against said User Registration Database using a compiler or processor.

3. The method according to claim 2, wherein said motion data may be of two or more types up to thirty types.

4. The method according to claim 2, wherein said User Registration Database and said Motion Capture Database are securely created within the same hardware add-on device for a standard computer.

5. The method according to claim 5, comprising the further step of rendering said third database to a module having output to a user.
